(19) United States
(12) Patent Application Publication
(10) Pub. No.: US 2005/0055455 A1
(43) Pub. Date: Mar. 10, 2005

(54) Development platform for peer-to-peer applications

(76) Inventor: Oren Asher, Thorn Hill (CA)

Correspondence Address: Oren Asher, 51 Bronte Road, Thorn Hill, ON, L3T 7J4, CA

(21) Appl. No.: 10/657,925

(22) Filed: Sep. 10, 2003

(51) Int. Cl. G06F 15/16

(52) U.S. Cl. 709/231

(57) ABSTRACT

A method for peer-to-peer image streaming including designating at least one digital image for inclusion within an album on a first computer, designating at least one user with whom the album is to be shared on the first computer, receiving at the first computer peer to peer requests issued by a designated user from a second computer, for viewing specified portions of a digital image within the album at a specified pixel width and height, and streaming by the first computer to the second computer, appropriate pixel data to the user within peer to peer responses, in response to the requests. A system and a computer-readable storage medium are also described and claimed.

### FIELD OF THE INVENTION

The present invention relates to peer-to-peer software applications in general, and more specifically to a software development platform for developing peer-to-peer applications.

### BACKGROUND OF THE INVENTION

Peer-to-peer networking involves direct socket connections between one computer and another for requesting and receiving data. Peer-to-peer networking differs fundamentally from conventional server-client distribution systems, in that peer-to-peer networking sets up connections between any two client computers and transfers data therebetween, rather than upload and download data through a central server. Peer-to-peer networking is used to share and exchange text and voice messages, text documents, multi-media files, such as audio and video files, and general files as well.

A first client computer that has data to share can elect to make the data visible to a network of computers. A second client computer can then explore the data over the network, and transfer it from the first client computer to the second client computer using a transfer protocol, such as the conventional file transfer protocol (FTP).

Peer-to-peer application development involves many intricacies, since it spans software programming for operating systems, graphical user interfaces, networking, user administration, security, encryption and multi-media processing. Such peer-to-peer intricacies include IP management, socket connections, access control, content management and digital rights management. As such, companies wishing to develop peer-to-peer offerings face a large barrier of entry.

### SUMMARY OF THE INVENTION

The present invention provides a core development platform for peer-to-peer application developers. In a preferred embodiment, an application developer need only specify the nature of requests and responses within an application, and the present invention automatically builds a full-scale peer-to-peer service around it.

Using the development platform of the present invention, a third party developer designs applications as if they were local standalone applications, and the present invention automatically integrates the applications within a peer-to-peer computing environment. The developer need only concentrate on the specific features of the application itself, and, through an application-programming interface (API), the present invention converts the developer's application into a genuine full-scale peer-to-peer application. The developer need not concern himself with peer-to-peer intricacies including encryption, security, IP management, socket connections, access control, content management and digital rights management.

The present invention also includes two novel peer-to-peer applications, developed using the above development platform; namely, (i) peer-to-peer image sharing, and (ii) private e-mail.

Peer-to-peer image sharing enables individual users to share their images with one another. Using the present inventions, users can share high-resolution images, of the quality and resolution captured by today's and tomorrow's digital cameras, with one another in such a way that shared images can be remotely viewed interactively using pan and zoom controls to explore the images up to their full high quality resolution. Prior art image sharing technology requires use of a central image server computer, within which shared images are hosted. Use of a central image server has many drawbacks, when images are intended to be shared among a group of individuals. Such drawbacks include limitations on memory, cost for hosting images, time to upload images from an individual's computer to the central image server, and complexity of updating images. Moreover, as capture devices provide better and better quality images, the image files grow in size, which makes the above drawbacks more and more severe. The present invention overcomes all of these drawbacks by eliminating the use of a central image server.

Private e-mail is a way to securely exchange messages between two computers, without intermediate message storing. Prior art e-mail exchange typically stores messages on a central mail server until they are requested by recipients. As such, prior art e-mail exchange is vulnerable to undetected unauthorized third party access and copying, which is a major drawback of current e-mail systems. Private e-mail overcomes this drawback by eliminating intermediate storage of messages.

In a preferred embodiment of the present invention, private e-mail is implemented in a seamless way with conventional e-mail clients such as Microsoft Outlook and Netscape Communicator. Thus, a user can prepare an e-mail message, including any attachments thereto, using, say, Outlook, and can also send the message using Outlook. Based on the e-mail address of the recipient, Outlook will forward the message to a special e-mail manager residing on the user's computer, which handles the message as a private e-mail message. Specifically, the e-mail manager holds the message until such time as the recipient is on-line, and then sends the message directly to the recipient's e-mail manager. In turn, the recipient's e-mail manager forwards the incoming e-mail message to Outlook. Thus the recipient receives his incoming e-mail message within Outlook, as usual. The special processing for private e-mail is handled seamlessly by the e-mail managers within the sender's and the recipient's computers.

There is thus provided in accordance with a preferred embodiment of the present invention a method for peer-to-peer image streaming including designating at least one digital image for inclusion within an album on a first computer, designating at least one user with whom the album is to be shared on the first computer, receiving at the first computer peer to peer requests issued by a designated user from a second computer, for viewing specified portions of a digital image within the album at a specified pixel width and height, and streaming by the first computer to the second computer, appropriate pixel data to the user within peer to peer responses, in response to the requests.

There is further provided in accordance with a preferred embodiment of the present invention a method for peer-to-peer application development including receiving a list of user actions and corresponding responses, for a software application, and generating a peer-to-peer software application for which the corresponding responses listed are performed by a first peer computer, in response to the user actions listed being performed by a second peer computer.

There is yet further provided in accordance with a preferred embodiment of the present invention a method for peer-to-peer private e-mail including receiving an e-mail message, sent from a first peer computer to itself, intended for delivery to a second peer computer, determining if the second peer computer is on-line, and sending the e-mail message to a second peer computer only when the second peer computer is on-line.

There is moreover provided in accordance with a preferred embodiment of the present invention a computer-readable storage medium storing program code for causing a computer to perform the steps of designating at least one digital image for inclusion within an album on a first computer, designating at least one user with whom the album is to be shared on the first computer, receiving at the first computer peer to peer requests issued by a designated user from a second computer, for viewing specified portions of a digital image within the album at a specified pixel width and height, and streaming by the first computer to the second computer, appropriate pixel data to the user within peer to peer responses, in response to the requests.

There is additionally provided in accordance with a preferred embodiment of the present invention a computer-readable storage medium storing program code for causing a computer to perform the steps of receiving a list of user actions and corresponding responses for a software application, and generating a peer-to-peer software application for which the corresponding responses listed are performed by a first peer computer, in response to the user actions listed being performed by a second peer computer.

There is further provided in accordance with a preferred embodiment of the present invention a computer-readable storage medium storing program code for causing a computer to perform the steps of receiving an e-mail message, sent from a first peer computer to itself, intended for delivery to a second peer computer, determining if the second peer computer is on-line, and sending the e-mail message to a second peer computer only when the second peer computer is on-line.

There is yet further provided in accordance with a preferred embodiment of the present invention a system for peer-to-peer image streaming including a user interface for designating at least one digital image for inclusion within an album on a first computer, and for designating at least one user with whom the album is to be shared on the first computer, a receiver for receiving at the first computer peer to peer requests issued by a designated user from a second computer, for viewing specified portions of a digital image within the album at a specified pixel width and height, and a transmitter for streaming by the first computer to the second computer, appropriate pixel data to the user within peer to peer responses, in response to the requests.

There is moreover provided in accordance with a preferred embodiment of the present invention a system for peer-to-peer application development including an application programming interface for receiving a list of user actions and corresponding responses, for a software application, and an application builder for generating a peer-to-peer software application for which the corresponding responses listed are performed by a first peer computer, in response to the user actions listed being performed by a second peer computer.

There is additionally provided in accordance with a preferred embodiment of the present invention a system for peer-to-peer private e-mail including a receiver for receiving an e-mail message, sent from a first peer computer to itself, intended for delivery to a second peer computer, a peer-to-peer user identifier for determining if the second peer computer is on-line, and a transmitter for sending the e-mail message to a second peer computer only when the second peer computer is on-line.

### BRIEF DESCRIPTION OF THE DRAWINGS

The present invention will be understood and appreciated more fully from the following detailed description, taken in conjunction with the drawings in which:

FIG. 1 is a simplified block diagram of a peer-to-peer image streaming system, in accordance with a preferred embodiment of the present invention;

FIG. 2 is a simplified block diagram of a peer-to-peer private e-mail system, in accordance with a preferred embodiment of the present invention; and

FIG. 3 is a simplified flowchart of a method for private e-mail communication, in accordance with a preferred embodiment of the present invention.

### DETAILED DESCRIPTION OF A PREFERRED EMBODIMENT

The present invention provides a core development platform for peer-to-peer application developers. In a preferred embodiment, an application developer need only specify the nature of requests and responses within an application, and the present invention builds a peer-to-peer service around it.

The present invention also includes two novel peer-to-peer applications, developed using the above core development platform; namely (i) peer-to-peer image streaming; and (ii) private e-mail.

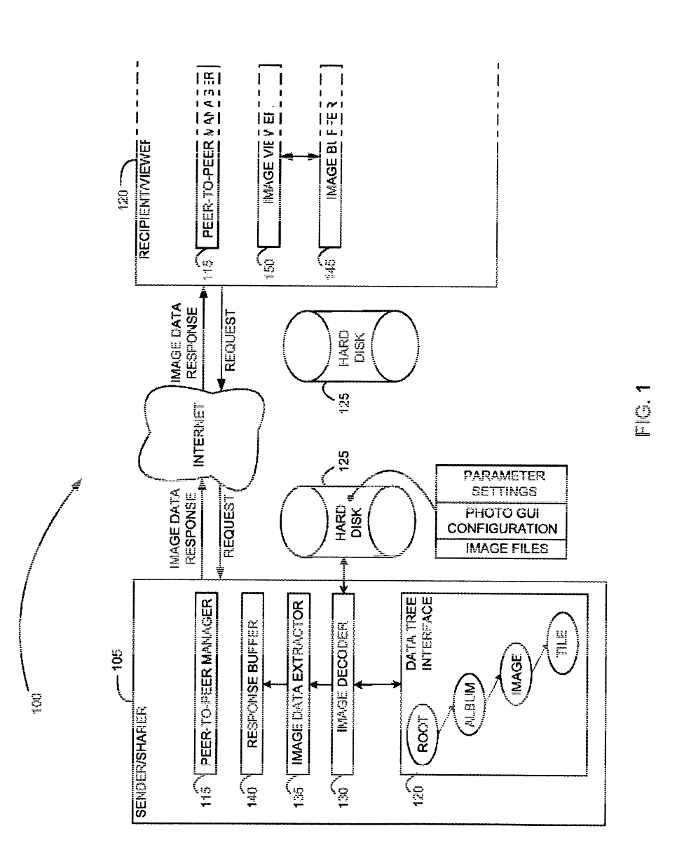

Reference is now made to FIG. 1, which is a simplified block diagram of a peer-to-peer image streaming system 100, in accordance with a preferred embodiment of the present invention. Shown in FIG. 1 are two computers, indicated by numerals 105 and 110, communicating with one another using peer-to-peer managers 115. Computer 105 is a sender/sharer computer, which shares digital images with other computers that are currently using an on-line peer-to-peer service. Computer 110 is a recipient/viewer computer, which views interactively views the digital images shared by computer 10.5

In a preferred embodiment of the present invention, interactive viewing of shared images is performed as follows. Computers 105 and 110 initially activate a peer-to-peer image sharing service, such as the service described in applicant's co-pending patent application U.S. Ser. No. 09/976,169 entitled METHOD AND SYSTEM FOR PEER-TO-PEER IMAGE STREAMING, filed on Oct. 11, 2001. After the image sharing service is running, computer 110 sends interactive requests to computer 105, and in turn computer 105 sends responses with image pixel data to computer 110.

In a preferred embodiment of the present invention, a user of computer 105 designates which digital images he wishes to share, and organizes them into at least one album, an album being a collection of at least one digital image with a common descriptor. Preferably, the digital images themselves do not have to be physically arranged in memory or disk according to the albums; but instead a data structure 120 in the form of a tree stores references to the digital images, organized according to albums. Additionally, data structure 120 may include references to tiles generated from of digital images. A “tile” of a digital image is a rectangular portion of pixel data, such as a 512×512 portion, from the digital image, or from a sub-sampled version of the digital image. Tiles referenced in data structure 120 are preferably stored in RAM or on a hard disk 125 in compressed format, such as the JPEG image format.

Preferably, requests sent by computer 110 to computer 105 specify portions of specific digital images within specific albums, for display at specified pixel widths and heights. After receiving such a request, an image decoder 130 identifies appropriate tiles necessary to fulfill the request, and checks whether or not such tiles are already available within the computer 105 RAM or hard disk 125. If at least one such tile is not already available within the tile cache, then image decoder 130 fetches at least one image from hard disk 125, as appropriate, generates the required tiles, and preferably saves them within its RAM or hard disk 125. An image data extractor 135 decodes the tile and applies appropriate image processing functions in order to generate the portions specified within the requests. A response buffer 140 sends the requested image portions to computer 110 for viewing.

Computer 110 includes an image buffer 145 for receiving incoming image data, and an image viewer 150 for rendering image data requested by computer 110, thereby enabling computer 110 to display image data from a digital image shared by computer 105, on a computer monitor connected to computer 110.

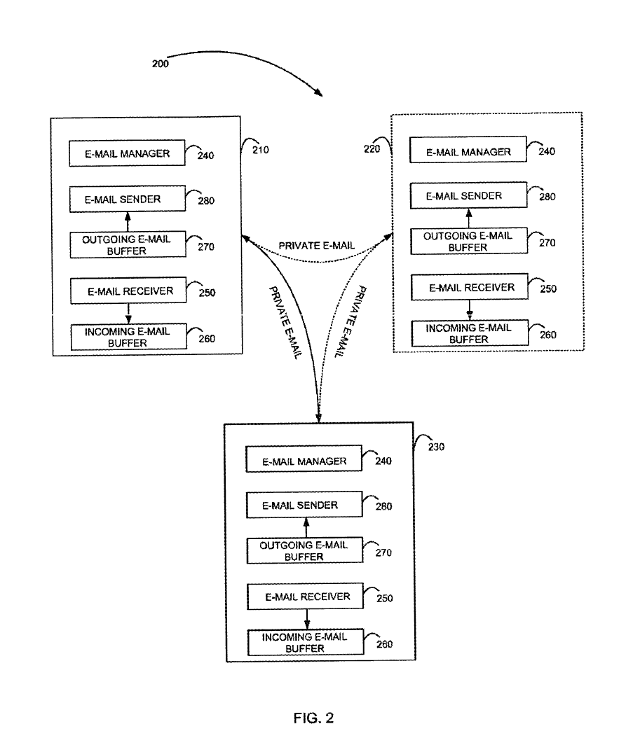

Reference is now made to FIG. 2, which is a simplified block diagram of a peer-to-peer private e-mail system 200, in accordance with a preferred embodiment of the present invention.

Shown in FIG. 2 are computers 210, 220 and 230 communicating via a peer-to-peer application. In a preferred embodiment of the present invention, computers 210, 220 and 230 use the peer-to-peer application to notify one another when they are on-line and available. Each computer include as e-mail manager 240, which serves to control incoming and outgoing e-mail. Incoming e-mail is received by an e-mail receiver 250 and forwarded to an incoming e-mail buffer 260. Outgoing e-mail is transmitted by an e-mail sender 270.

In accordance with a preferred embodiment of the present invention, e-mail sender 270 does not send an e-mail message to its destination unless the destination computer is currently on-line and communicating via the peer-to-peer application. Otherwise, e-mail manager 240 stores the e-mail message in an outgoing e-mail buffer 280, and sends it at a later time when it becomes aware that the destination computer is available. This is indicated in FIG. 2 by dashed lines around computer 220, and on arrows connecting computers 210 and 230 to computer 220. The dashed lines indicate that computer 220 is currently not available via the peer-to-peer application, and the dashed arrows indicate private e-mail that is buffered, and sent only at a later time when computer 220 is available.

It may thus be appreciated that FIG. 2 affords users of a peer-to-peer application with a private e-mail service, whereby e-mail messages are sent directly between users, without intervention of an Internet service provider mail server. In a preferred embodiment, the private e-mail system of the present invention works seamlessly with standard e-mail clients such as Netscape Communicator and Microsoft Outlook. Preferably, peer-to-peer managers 130 are identified with SMTP addresses. Outgoing mail from a standard e-mail client within computer 110, say, Microsoft Outlook, is sent to computer 110's peer-to-peer manager 130.

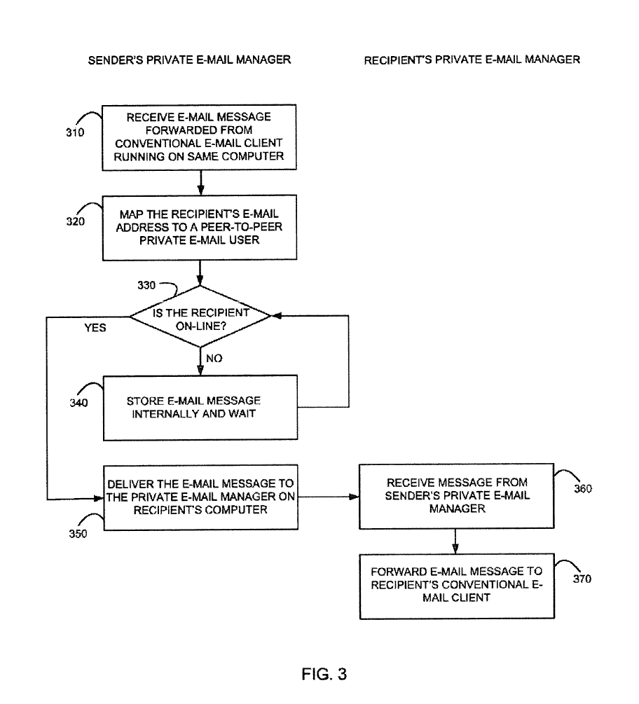

Reference is now made to FIG. 3, which is a simplified flowchart of a method for private e-mail communication, in accordance with a preferred embodiment of the present invention. FIG. 3 is divided into two columns, a leftmost column indicating operations performed by an e-mail manager on a sender's computer, such as e-mail manager 240 (FIG. 2), and a rightmost column indicating operations performed by an e-mail manager on a recipient's computer.

At step 310, the sender's e-mail manager receives an e-mail message forwarded by an e-mail client, such as Microsoft Outlook, residing on the sender's computer. Generally, the e-mail message forwarded by Outlook is an e-mail message drafted by the sender within Outlook. At step 320 the sender's e-mail manager identifies the recipient of the e-mail as a specific user of a peer-to-peer private e-mail application. At step 330 the sender's e-mail manager determines whether or not the recipient is currently available on the peer-to-peer application. If not, the sender's e-mail manager does not send the message to the recipient, but instead stores the e-mail message internally at step 340, and waits until such time as the recipient is available. If at step 330 it is determined that the recipient is available on the peer-to-peer application, then at step 350 the sender's e-mail manager sends the e-mail message to the recipient's e-mail manager.

At step 360 the recipient's e-mail manager receives the e-mail sent from the sender's computer, and at step 370 the recipient's e-mail manager forwards the e-mail to the recipient's e-mail client, residing on the recipient's computer. The recipient is thus able to receive his e-mail within his conventional e-mail client.

It may be appreciated by those skilled in the art that the method illustrated in FIG. 3 readily applies to e-mail messages with more than one recipient, perhaps with some recipients enables for private e-mail and some recipients not enables. For those recipients enabled for private e-mail, the method of the present invention operates as in FIG. 3. For those recipients not enabled for private e-mail, the e-mail message is sent directly from the sender's e-mail client to the recipient's e-mail server, as with conventional e-mail communication.

The peer-to-peer image sharing service illustrated in FIG. 1 and the peer-to-peer private e-mail service illustrated in FIG. 2 are but two examples of peer-to-peer services enabled by the present invention. The present invention provides a core development platform for peer-to-peer application developers. In a preferred embodiment, an application developer need only specify the nature of requests and responses within an application, and the present invention builds a peer-to-peer service around it.

Using the development platform of the present invention, a third party developer designs applications as if they were single-user local applications, and the present invention automatically integrates the applications within a peer-to-peer computing environment. The developer need only concentrate on the specific features of the application itself, as if it were a standalone application, and, through an application programming interface (API), the present invention converts the application a genuine peer-to-peer application. The developer need not concern himself with peer-to-peer intricacies including encryption, security, IP management, socket connections, access control, content management and digital rights moanagement.

It will be appreciated by persons skilled in the art that the present invention is not limited by what has been particularly shown and described hereinabove. Rather the present invention includes combinations and sub-combinations of the various features described hereinabove as well as modifications and extensions thereof which would occur to a person skilled in the art and which do not fall within the prior art.

1. A method for peer-to-peer image streaming comprising:
designating at least one digital image for inclusion within an album on a first computer;
designating at least one user with whom the album is to be shared on the first computer;
receiving at the first computer peer to peer requests issued by a designated user from a second computer, for viewing specified portions of a digital image within the album at a specified pixel width and height; and
streaming by the first computer to the second computer, appropriate pixel data to the user within peer to peer responses, in response to the requests.

2. A method for peer-to-peer application development comprising:
receiving a list of user actions and corresponding responses, for a software application; and
generating a peer-to-peer software application for which the corresponding responses listed are performed by a first peer computer, in response to the user actions listed being performed by a second peer computer.

3. A method for peer-to-peer private e-mail comprising:
receiving an e-mail message, sent from a first peer computer to itself, intended for delivery to a second peer computer;
determining if the second peer computer is on-line; and
sending the e-mail message to a second peer computer only when the second peer computer is on-line.

4. A computer-readable storage medium storing program code for causing a computer to perform the steps of:
designating at least one digital image for inclusion within an album on a first computer;
designating at least one user with whom the album is to be shared on the first computer;
receiving at the first computer peer to peer requests issued by a designated user from a second computer, for viewing specified portions of a digital image within the album at a specified pixel width and height; and
streaming by the first computer to the second computer, appropriate pixel data to the user within peer to peer responses, in response to the requests.

5. A computer-readable storage medium storing program code for causing a computer to perform the steps of:
receiving a list of user actions and corresponding responses, for a software application; and
generating a peer-to-peer software application for which the corresponding responses listed are performed by a first peer computer, in response to the user actions listed being performed by a second peer computer.

6. A computer-readable storage medium storing program code for causing a computer to perform the steps of:
receiving an e-mail message, sent from a first peer computer to itself, intended for delivery to a second peer computer;
determining if the second peer computer is on-line; and
sending the e-mail message to a second peer computer only when the second peer computer is on-line.

7. A system for peer-to-peer image streaming comprising:
a user interface for designating at least one digital image for inclusion within an album on a first computer, and for designating at least one user with whom the album is to be shared on the first computer;
a receiver for receiving at the first computer peer to peer requests issued by a designated user from a second computer, for viewing specified portions of a digital image within the album at a specified pixel width and height; and
a transmitter for streaming by the first computer to the second computer, appropriate pixel data to the user within peer to peer responses, in response to the requests.

8. A system for peer-to-peer application development comprising:
an application programming interface for receiving a list of user actions and corresponding responses, for a software application; and
an application builder for generating a peer-to-peer software application for which the corresponding responses listed are performed by a first peer computer, in response to the user actions listed being performed by a second peer computer.

9. A system for peer-to-peer private e-mail comprising:
a receiver for receiving an e-mail message, sent from a first peer computer to itself, intended for delivery to a second peer computer;
a peer-to-peer user identifier for determining if the second peer computer is on-line; and
a transmitter for sending the e-mail message to a second peer computer only when the second peer computer is on-line.
